(19) United States
(12) Patent Application Publication
(10) Pub. No.: US 2010/0135646 A1
(43) Pub. Date: Jun. 3, 2010

(54) STORAGE/PLAYBACK METHOD AND APPARATUS FOR MPEG-2 TRANSPORT STREAM BASED ON ISO BASE MEDIA FILE FORMAT

(76) Inventors: Gun Bang, Daejon (KR); Hyun-Cheol Kim, Daejon (KR); Myung-Seok Ki, Daejon (KR); Hui-Young Kim, Daejon (KR); Han-Kyu Lee, Daejon (KR); Jin-Woo Hong, Daejon (KR)

Correspondence Address: LADAS & PARRY LLP, 224 SOUTH MICHIGAN AVENUE, SUITE 1600, CHICAGO, IL, 60604, US

(21) Appl. No.: 12/594,307

(22) PCT Filed: Apr. 4, 2008
(86) PCT No.: PCT/KR08/01933

§ 371 Date: Oct. 1, 2009

Related U.S. Application Data
(60) Provisional application No. 60/912,554, filed on Apr. 18, 2007.
(60) Provisional application No. 60/914,347, filed on Apr. 27, 2007.

(30) Foreign Application Priority Data
Apr. 4, 2007 (KR) 10-2007-0033478
Apr. 19, 2007 (KR) 10-2007-0038482
Oct. 15, 2007 (KR) 10-2007-0103592

(51) Int. Cl. H04N 7/26

(52) U.S. Cl. 386/124; 386/E05.001

(57) ABSTRACT

Provided are a method and apparatus for storing and playing back an MPEG-2 TS based on an ISO-based media file format. The method includes: storing a target MPEG-2 TS in an mdat box of the ISO-based media file format; and dividing the MPEG-2 TS by samples through time information, location information, size information, and Program Map Table (PMT) related information for random access and describing the divided samples in an moov box of the ISO based media file format.

### TECHNICAL FIELD

The present invention relates to a method and apparatus for storing and playing back Moving Picture Experts Group 2 (MPEG-2) transport stream (TS); and, more particularly, to a method and apparatus for storing and playing back an MPEG-2 TS based on an International Organization for Standardization (ISO) based media file format.

This work was supported by the IT R&D program of MIC/IITA [2006-S-082-02, “Development of Digital Multimedia Broadcasting Technology for Personalized Broadcasting”].

### BACKGROUND ART

Since no standard methods for storing an MPEG-2 transport stream (TS) and a digital multimedia broadcasting (DMB) TS were introduced, service providers or terminal manufacturers employ different storage methods individually or use a method for storing transmitted MPEG-2 TS as it is.

If each of the terminal manufacturers employs an independent storage method, a compatibility problem may arise among terminals for playing back contents, for preventing illegal distribution, and for storing metadata. In case of storing the MPEG-2 TS as it is, a user may have difficulties in random access playback or file reproduction.

Meanwhile, an Application Format for Digital Multimedia Broadcasting (DMB AF) was introduced as a storage format for DMB. The DMB AF has been in progress for standardization. Since the DMB AF supports compatibility between stored broadcasting contents files or stores AV data by an Elementary Stream unit, the DMB AF could not be used to store MPEG-2 TS which is generally used as a file format for distributing terrestrial DMB contents.

### DISCLOSURE

### Technical Problem

An embodiment of the present invention is directed to providing storing MPEG-2 transport stream in a terminal to enable random access playback and easy reproduction.

Another embodiment of the present invention is directed to providing storing MPEG-2 TS to have compatibility between terminals.

Still another embodiment of the present invention is directed to providing storing and playing back DMB contents in an MPEG-2 TS format while supporting random access.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for storing a Moving Picture Expert Group (MPEG)-2 Transport Stream (TS) in an International Organization for Standardization (ISO)-based media file format, including: storing a target MPEG-2 TS in an mdat box of the ISO-based media file format; dividing the MPEG-2 TS by samples through time information, location information, size information, and Program Map Table (PMT) related information for random access and describing the divided samples in an moov box of the ISO-based media file format.

In accordance with another aspect of the present invention, there is provided An apparatus for storing an MPEG-2 transport stream in an ISO-based media file formation, including: a signal receiver for receiving an external signal and outputting an MPEG-2 transport stream; a signal processor for extracting time information, location information, size information, and Program Map Table related information by a sample unit from the MPEG-2 TS outputted from the signal receiver; and a file memory for storing the MPEG-2 TS from the signal receiver in an mdat box of the ISO-based media file format as a sample for random access, and describing the extracted time information, location information, size information, and PMT related information in an moov box of the ISO-based media file format.

In accordance with further still another aspect of the present invention, there is provided a Digital Multimedia Broadcasting (DMB) terminal, including: a signal receiver for receiving a DMB signal and outputting an MPEG-2 transport stream; a file memory for storing the MPEG-2 TS in an ISO-based media file format where the MPEG-2 TS is stored in an mdat box of the ISO-based media file format as a sample, and time information, location information, size information, and Program Map Table related information of the MPEG-2 TS are stored by a sample unit in an moov box of the ISO-based media file formation; an MPEG-2 TS demultiplexer for analyzing PMT in the received MPEG-2 TS; an OD analyzer for extracting or analyzing OD information from the analyzed information; an MPEG-2 PES depacketizer and an MPEG-4 SL depacketizer for analyzing a packet through the analyzed or extracted PMT/OD information; an AV decoder for decoding the generated AV stream; an AV output unit for outputting the decoded AV stream, wherein random access playback for an MPEG-2 transport stream stored in the mdat box is controlled using information described in the moov box.

In accordance with yet another aspect of the present invention, there is providing a method for storing a DMB MPEG-2 Transport Stream in an ISO-based media file format, including: storing a target MPEG-2 TS to store in an mdat box of the ISO-based media file format; and describing time information, location information, Program Map Table related information, and Object Descriptor (OD) information in an moov box of the ISO-based media file format by a sample unit for randomly accessing the target MPEG-2 TS, where a boundary of the sample is identical to a boundary of the MPEG-2 TS.

In accordance with yet another aspect of the present invention, there is provided an apparatus for storing a DMB MPEG-2 Transport Stream in an ISO-based media file format, including: a signal receiver for receiving an external signal and outputting an MPEG-2 TS; a signal processor for extracting Program Map Table related information and Object Descriptor related information from the MPEG-2 TS outputted from the signal receiver; and a file memory for storing the outputted MPEG-2 TS from the signal receiver in an mdat box of the ISO-based media file format as a sample for random access, and describing time information, location information, Program Map Table related information, and Object Descriptor related information of the extracted MPEG-2 TS from the signal processor in an moov box of the ISO-based media file format by a sample unit.

### ADVANTAGEOUS EFFECTS

A method and apparatus for storing and playing back an MPEG-2 TS based on an ISO-based media file format according to the present invention enable random access playback of a transport stream and provide compatibility between terminals although DMB MPEG-2 TSs are stored in terminals. Also, the method and apparatus for storing and playing back an MPEG-2 TS based on an ISO-based media file format according to the present invention enable users to store not only a transport stream transmitted through a DMB AV broadcasting channel but also currently broadcasted AV data with related data thereof such as AV metadata and data service which is transmitted through a DAB MOT/TDC channel. Therefore, it enables a user to receive various data services with an AV service according to the present invention. Furthermore, it is expected to solve a problem of protecting contents using the method and apparatus according to the present invention when stored contents are distributed or reproduced.

### BRIEF DESCRIPTION OF THE DRAWINGS

FIG. 1 is a block diagram illustrating a terrestrial DMB terminal in accordance with an embodiment of the present invention.

FIG. 2 is a flowchart illustrating a method for storing MPEG-2 transport stream in accordance with an embodiment of the present invention.

FIG. 3 is a diagram illustrating an ISO-based multimedia file format in accordance with an embodiment of the present invention.

FIG. 4 is a diagram illustrating a trak box shown in FIG. 3.

FIG. 5 is a diagram illustrating a method for forming time information for randomly accessing a stored file in accordance with a first embodiment of the present invention.

FIG. 6 is a diagram illustrating a method for randomly accessing a stored file in accordance with a first embodiment of the present invention.

FIG. 7 is a block diagram illustrating a terrestrial DMB terminal in accordance with a second embodiment of the present invention.

FIG. 8 is a flowchart illustrating a method for storing MPEG-2 TS in accordance with a second embodiment of the present invention.

FIG. 9 is a diagram illustrating a structure of a DMB based MPEG-2 TS in accordance with an embodiment of the present invention.

FIG. 10 is a flowchart illustrating relation between MPEG-2 TS and PMT/OD that is a sample descriptor according to a second embodiment of the present invention.

### BEST MODE FOR THE INVENTION

The advantages, features and aspects of the invention will become apparent from the following description of the embodiments with reference to the accompanying drawings, which is set forth hereinafter.

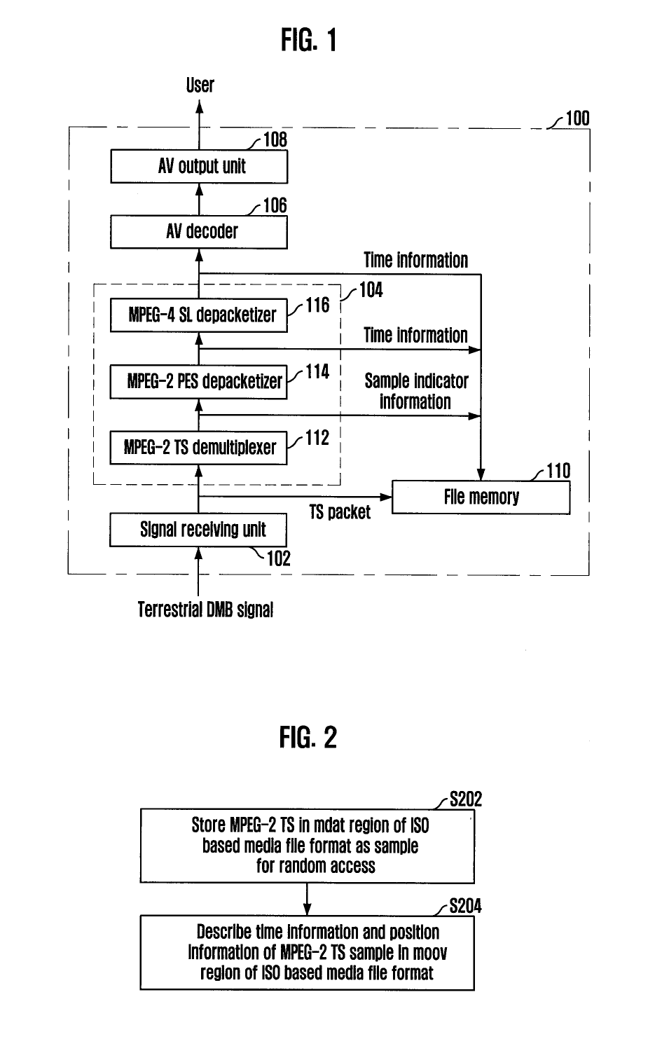

FIG. 1 is a block diagram illustrating a terrestrial Digital Multimedia Broadcasting (DMB) terminal in accordance with an embodiment of the present invention. As shown in FIG. 1, the terrestrial DMB terminal 100 includes a signal receiver 102, a signal processor 104, an audio video (AV) decoder 106, an AV output unit 108, and a file memory 110.

The signal receiver 102 receives, processes a terrestrial DMB signal, and outputs a Moving Picture Experts Group (MPEG)-2 Transport Stream (TS). The signal processor 104 extracts time information, location information, size information, and PMT related information from the MPEG-2 TS outputted from the signal receiver 101 as sample information. The file memory 110 stores the MPEG-2 TS outputted from the signal receiver 102 and the extracted information for random access from the signal processor 104 corresponding to the MPEG-2 TS.

Hereinafter, the signal processor 104 will be described in detail. As shown, the signal processor 104 includes an MPEG-2 TS demultiplexer 112, an MPEG-2 packetized elementary stream (PES) depacketizer 114, and an MPEG-4 synchronization layer (SL) depacketizer 116.

The MPEG-2 TS demultiplexer 112 demultiplexes the MPEG-2 TS outputted from the signal receiver 102, outputs an MPEG-2 PES packet, and informs the file memory 110 whether random access is possible or not using a demultiplexing result. The MPEG-2 PES depacketizer 114 receives the MPEG-2 PES packets from the MPEG-2 TS demultiplexer 112, depacketizes the received packets, and transfers time information which is extracted while depacketizing the received packets to the file memory 110. Although a PES includes A/V data in case of a general MPEG-2 TS, A/V data is packetized to an MPEG-4 SL packet in order to use MPEG-4 systems in case of terrestrial DMB. Therefore, the MPEG-4 SL depacketizer 116 receives MPEG-4 SL packets and extracted A/V data according to time by de packetizing.

The AV decoder 106 decodes an AV stream, and the AV output unit 108 outputs the decoded AV stream from the AV decoder 106 to a user.

FIG. 2 is a flowchart illustrating a method for storing MPEG-2 TS in accordance with an embodiment of the present invention. At first, among MPEG-2 TSs outputted from the signal receiver 102, target MPEG-2 TSs are stored in as an International Organization for Standardization (ISO) based media file format of an mdat box as a sample for random access at step S202. Here, the boundary of a sample in the MPEG-2 TS is matched to a boundary of a packet, a GOP, and an entire MPEG-2 TS. A fundamental definition of a sample may be defined when it is stored.

At step S204, time information, location information, size information, and Program Map Table (PMT) related information of a sample for MPEG-2 TS random access are described in an moov box of the ISO-based media file format.

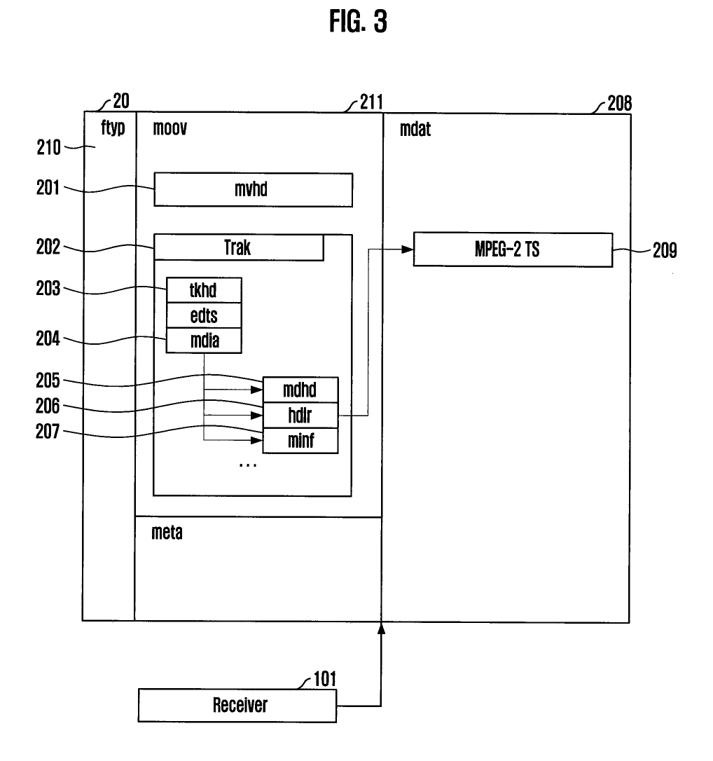

FIG. 3 is a diagram illustrating a file format in accordance with an embodiment of the present invention. A TS packet received at the signal receiver 102 is stored in the file memory 110 in a file format as shown in FIG. 3. Based on the file storage format 20, an MPEG-2 TS is stored in an mdat 208. In case of storing an MPEG-2 TS, various types of additional information are added in the file. For example, the extracted sample time information, sample location information, and PMT related information are described in the moov 211 for random access playback for MPEG-2 TS stored in the mdat 208.

In case of storing an MPEG-2 TS, time information for playing back the stored MPEG-2 TS is described in the moov 211.

Therefore, a time scale is stored in an mvhd region 201 of the moov 211 for measuring a unit time. This unit may be expressed as a unit defined in an MPEG-2 system specification

A Trak 202 includes a tkhd region 203 for describing basic visual expression for video of an MPEG-2 TS stored in the mdat 208 in width and height and an mdia 204 for describing sample time information and location information of MPEG-2 TS stored in a file for playing back the MPEG-2 TS from a predetermined location thereof through random access. The mdia 204 will be described, hereinafter.

It is necessary to add preliminary information for playback in order to form a file for MPEG-2 TS random access playback. A hdlr 206 of the mdia 204 may store related information thereof. An minf 207 includes a sample table box (stbl) for having time information and location information for a user to perform random access playback when an MPEG-2 TS is reproduced.

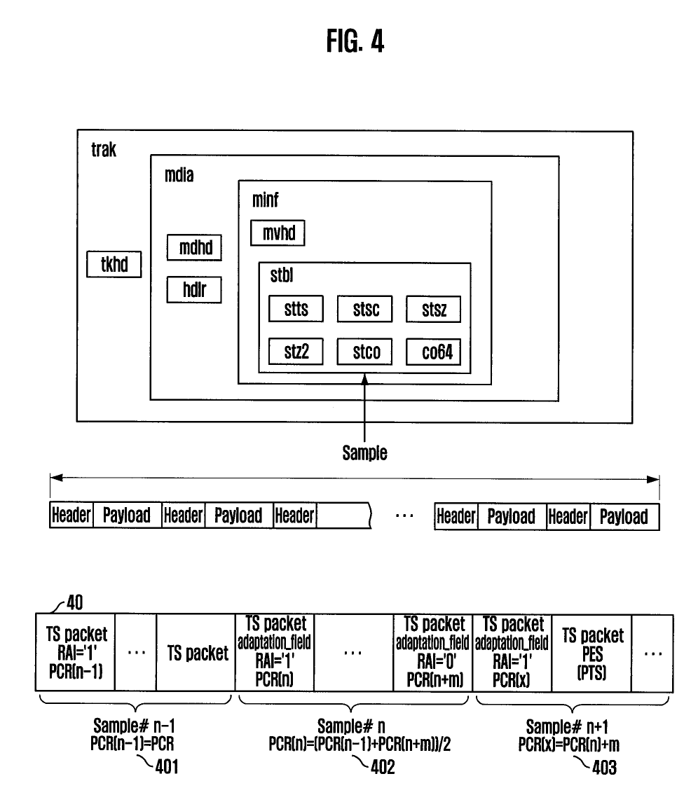

FIG. 4 is a diagram illustrating a trak box shown in FIG. 3. FIG. 4 shows a structure of a sample or a chunk for TS random access in a file and a method for recording time information and location information.

For random access playback of stored MPEG-2 TS of ISO media file format, it should describe sample units in stored MPEG-2 TS file of ISO media file format. Here, a sample unit is expressed as stsd, stts, stsc, stco, and stsz in stbl region.

A user can obtain a playback time of each sample and a corresponding sample number through stts (decoding time to sample box). Also, a user can estimate a location of each sample through the sample number and stsz (Sample Size box).

Furthermore, a user can obtain information how many samples are included in each chunk through stsc (Sample To Chunk box) and can also obtain sample description expressed in corresponding stsd (Sample Description box) through sample_description_index. Moreover, a user may obtain a location of each chuck through stco (Chunk Offset box).

In the present embodiment, a sample must be decided based on a decodable location of a terminal. According to MPEG-2 TS specification, if a packet includes a Random Access Indicator (RAI) field expressed as ‘1 ’ in adaptation_field, the packet includes a start byte of a video sequence header or a start bye of an audio frame. Also, a playback time value of a transport stream must be matched with a System Time Clock (STC) of a terminal in order to correctly playback an MPEG-2 transport stream. Therefore, it is necessary to detect a Program Clock Reference (PCR) value included in a transport stream.

The PCR value is transmitted through a transport stream at an interval of 100 ms. A PCR value of a corresponding sample must be known for random access playback of a transport stream based on the sample.

For example, samples 401, 402, and 403 of an MPEG-2 transport stream, decided according to an embodiment of the present invention, are shown in a lower end of FIG. 4.

The 13818-1 MPEG-2 system specification defines a Random Access Indicator (RAI) field in an adaptation_field as an identifier for making random access of an MPEG-2 transport stream. It also defines that a first payload of a corresponding packet includes a start byte of a video sequence or an audio sequence if RAI is ‘1’ (RAI=1). Since a PCR value may be included in the adaptation_field of a TS packet having the described properties and transmitted with the adaptation_field of the TS packet, there is a large chance that a PCR value is included if RAI is ‘1’.

Therefore, in case of the sample 401, a sample start location may be a first byte location of a TS packet having an adaptation_field with RAI=1.

If a TS packet having RAI=1 has no a PCR value, a PCR value can be obtained through predicting a PCR value based on PCR values of a previous TS packet and a next TS packet like the sample 402.

Like the sample 403, a PCR value of a TS packet can be obtained through a PCR value of a previous sample.

In the present embodiment, a start location of a sample is defined as a TS packet having a PCR value predicted based on PCR values of a previous sample and a next sample in case of a TS packet having a PCR value with RAI=‘1’ or an RS packet not having a PCR value. A PCR value of each sample can be obtained as Table 1.

```
TABLE 1
if (Packet.Sample_PCR(n) = Null) {
    Packet.Sample_PCR(n) = Packet.Sample_PCR(n−1) + delta; ,
where delta is estimated value for approximated PCR.
} else Packet.Sample_PCR(n) = PCR;

[symbol]

if (Packet.Sample_PCR(n) = Null {
    Pecket.Sample_PCR(n) = (Packet.Sample_PCR(n−1)+
Packet.Sample_PCR(n+1))/alpha; , where alpha is estimated value for
approximated PCR
} else Packet.Sample_PCR(n) = PCR;
```

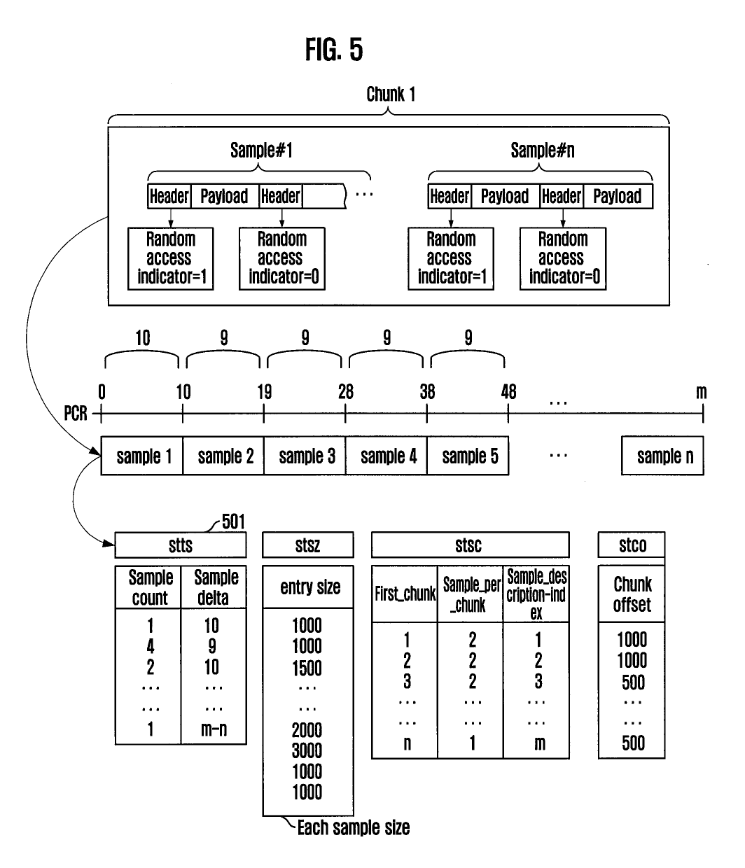

FIG. 5 is a diagram illustrating a method for forming time information for random access of an MPEG-2 TS in accordance with a first embodiment of the present invention.

An ISO-based media file format according to the present embodiment includes a sample table box (stbl) for describing temporal and spatial properties of media samples.

In the ISO-based media file format according to the present embodiment, random-accessible Packetized Elementary Streams (PESs) are grouped by a sample or a chunk unit for random access playback for a stored MPEG-2 TS file. Such information is recorded in stts, stsc, stsz, and stco shown in FIG. 4.

In case of a general MPEG-2 transport stream, a Program Clock Reference (PCR) and a Decoding Time Stamp (DTS) of a PES packet header are used to decide decoding or a time (or offset value). Such values are described in each stts 501 (or ctts).

Since a PES packet includes a Synchronization Layer (SL) packet in case of DMB contents, PTS means a time for decoding a SL packet, not a time of playing back a media. Time information for decoding is described in an Object Clock Reference (OCR), Decoding Time Stamp (DT), and Composition Time Stamp (CTS) in the SL packet.

The present invention proposes three methods for sample configuration according to time information for random access of an MPEG-2 TS in the ISO-based media file format as follows.

In the first method, a PCR value is extracted from each packet, and the extracted PCR value is described in stts for sample configuration. In this case, the first method is advantageously simply because the necessary information can be extracted by parsing only adaptation_field information of an MPEG-2 TS. On the contrary, it has a problem that a playback time is not matched because a system clock is initialized based on a PCR value and the initialized system clock is used as a reference for decoding time (PTS/DTS).

In the second method, a PTS value of a sample is described in stts when a PTS value is used for random access. In this method, time information may be obtained through parsing a PES packet. In case of a general MPEG-2 TS having including an MPEG-4 SL packet, a real playback time is matched with the obtained time information. But, the obtained time information is not matched with the real playback time in case of DMB contents including an MPEG-4 SL packet.

In the third method, a DTS value or a CTS value of media is described in stts because an accurate synchronization time is obtained by parsing a SL packet for DMB contents. In this method, it is required to perform parsing until a SL header, and a decoding time or a playback time is matched with time information recorded in a file.

In FIG. 5, numeral units are only example. Units for real time and size are described in ISO/IEC 13818-1 MPEG-2 system specifications and a transmitted real data structure.

A terminal essentially needs information in a Program Association Table (PAT) and a Program Map Table (PMT) for reproducing an MPEG-2 transport stream. According to the ISO/IEC 13818-1 MPEG-2 system specification, video/audio/data are formed as multiplexed and packetized transport streams, and related information of the transport streams is described in the PAT and the PMT. The PMT includes information for identifying a packet of video, audio, and data. Therefore, it is necessary to have the PMT information to playback an MPEG-2 TS stored in the terminal. In the present embodiment, the PMT is stored directly in the moov 211 region of the ISO media file format to enable a user to random access and playback a stored MPEG-2 TS, or a terminal directly finds a PMT packet from an MPEG-2 TS stored in the mdat region 208.

Table 2 and Table 3 illustrate a method for forming a PMT information according to an embodiment of the present invention.

```
TABLE 2
        (501) Handler Box
        syntax
        aligned(8) class HanflerBox extends FullBox(‘hdlr’,
        version = 0, 0) {
            unsigned int(32) pre-defined = 0;
            unsigned int(32) handler-type;
            const unsigned int(32)[3] reserved = 0;
        }
        hadler-type Semantic
          ‘vide’ video track
          soun’ audio track
          ‘hint’ hint track
        (502) Hint Media Header Box
        syntax
        aligned(8) class HintMediaHeaderBox extends FullBox(‘hmhd’,
        version = 0, 0) {
            unsigned int(16) maxPDUsize;
            unsigned int(16) avgPDUsize;
            unsgined int(32) maxbitrate;
            unsgined int(32) avrbitrate;
            unsigned int(32) reserved = 0;
        }
(503) Sample Description Box
syntax
aligned(8) class SampleDescriptionBox (unsigned int(32)
handler_type) extends
FullBox (‘stsd’, 0, 0) {
    int i;
    unsigned int(32) entry_count;
    for(i = 1; i<= entry_count; i++) {
      switch (handler_type) {
        case ‘soun’: // for audio tracks
            AudioSampleEntry( );
            break;
        case ‘vide’: // for video tracks
            VisualSampleEntry( );
            break;
        case ‘hint’: // for Hint tracks
            HintSampleEntry( );
            break;
      }
    }
}
```

TABLE 3

| (504) MPEG-2 TS Sample Entry | |
|---|---|
| syntax | |
| class M2TSSampleEntry( ) extends HintSampleEntry (‘m2ts’) { | |
| unsigned int(64) transporttime_offset; | |
| unsigned int(64) record_time; | |
| unsigned int(16) reserved = 0; | |
| unsigned int(8) sample_type; | // one-sampleTSornot |
| unsigned int(8) pmt_type; | // not stored or inlined |
| unsigned int(8) od_type; | // not stored or inlined |

| | |
|---|---|
| if (pmt_type == 1) { | // inline |
| unsigned int(16) pmt_size; | // sizeofPMTinbytes |
| byte[pmt_size] pmt_data; | // actualPMTsectiondata |
| } | |
| if (od_type == 1) { | // inline |
| unsigned int(16) od_size; | // sizeoftheODStreaminbytes |
| byte[od_size] od_data; | // actualODStreamdata(ES) |
| } | |
| } | |

In case of storing an MPEG-2 TS according to the present embodiment, handler_type in the Handler Box 501 of Table 2 is set to ‘hint’, and major fields of the Hint Media Header Box 502 of Table 2 are processed as follows.

maxPDUsize: is fixed to 188 bytes//MPEG-2 TS packet size

avgPDUsize: is fixed to 188 bytes//MPEG-2 TS packet size

maxbitrate: maxim transmit rate of transport streamavgbitrate: average transmit rate of transport stream

Additionally, HintSampleEntry( ) is setup according to handler_type of the Sample Description Box 503 of Table 2.

In this case, a protocol of HintSampleEntry may follow syntax of the M2TSSampleEntry 504 of Table 3 by setting up the protocol as ‘m2ts’. Each field thereof has following meanings.

transporttime_offset: is a time offset between a first time of transmitting a transport stream and a starting time of playing back a stored transport stream. When transporttime_offset is 0, it is not followed.

recordtime_offset: is a recoding time (from 24:00 1904/1/1 to 10:00 2006/03/10 in KOR based on UTC, for example)

sample_type: means whether a entire TS is treated as one sample unit or is divided into a plurality of samples. If sample_type is ‘0’, an entire MPEG-2 TS is setup ad one sample. If sample_type is ‘1’, a plurality of packets is grouped as one sample.

pmt_type: means whether or not PMT is included in byte[pmt_size]. If pmt_type is ‘1’, the PMT is directly included. If pmt_type is ‘0’, a terminal uses a PMT in an MPEG-2 TS stored in mdat.

pmt_size: assigns a size of PMT when pmt_type=‘1’.

od_type: decides whether or not an Object Descriptor (OD) is included in byte[pmt_size]. If od_type is ‘1’, the OD is directly included therein. If od_type is ‘0’, a terminal uses an OD in an MPEG-2 TS stored in mdat.

od_size: assigns a size of an OD when od_type=‘1’.

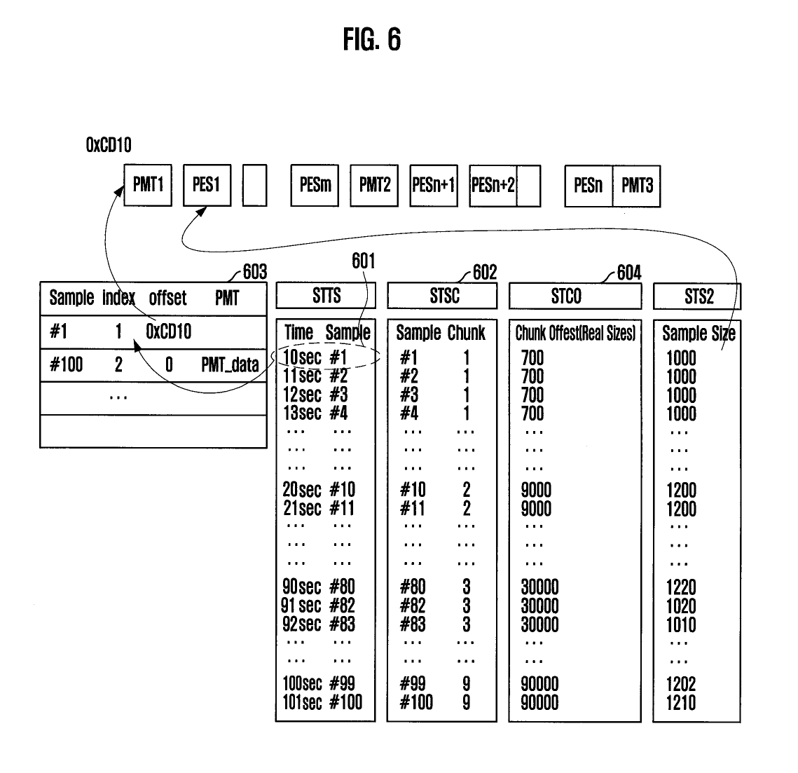

FIG. 6 is a diagram illustrating a method for randomly accessing a stored file in accordance with a first embodiment of the present invention.

When a user requests random access to a file formed according to the above described method, a sample corresponding to a random access time is searched using the stts box in the moov box based on ISO/IEC 14496-12 specifications in order to access a transport stream packet corresponding to the random access time at step S601. Then, a chunk 602 corresponding to the sample is searched through a stsc box, and a PMT is searched through the sample_description_index in a corresponding sample_description 503 of Table 2 603. Also, a location offset value of the chunk is searched using a stco box 604. As described above, a user can find a location for random access using the location of the chunk and the sample size of the ‘stsz’ box.

The PMT information is essential for playing back a transport stream from the random access location. The PMT information may be easily found by expanding or newly defining the TSSampleEntry 503 of Table 2 as a file format defined in ISO/IEC 14496-12 like Table 2 and Table 3.

Meanwhile, DMB contents are transmitted by packetizing audio and video into a SL packet using MPEG-4 systems standard and multiplexing the SL packet to an MPEG-2 TS unlike a related transmission method that directly multiplexes audio and video into an MPET-2 TS. In order to transmit terrestrial DMB, all of audio/video and image objects are packetized to SL packets. In order to transmit satellite DMB, data objects except audio and video are packetized to SL packets and transmitted.

Since the decoding information and type information of a media object are included in an Object Descriptor (OD) in the MPEG-4 systems standard, changes of current audio and video or data objects cannot be detected if an OD is not analyzed in case of DMB contents. That is, if a user directly accesses media in a transport stream directly without analyzing the OD, it is difficult to randomly access data except audio and video. Particularly, if a transmit rate for audio and video or the number of frames is changed while transmitting terrestrial DMB data, it is even difficult to access the audio and video. Therefore, it is necessary to access the OD first in order to enable random access of stored DMB contents.

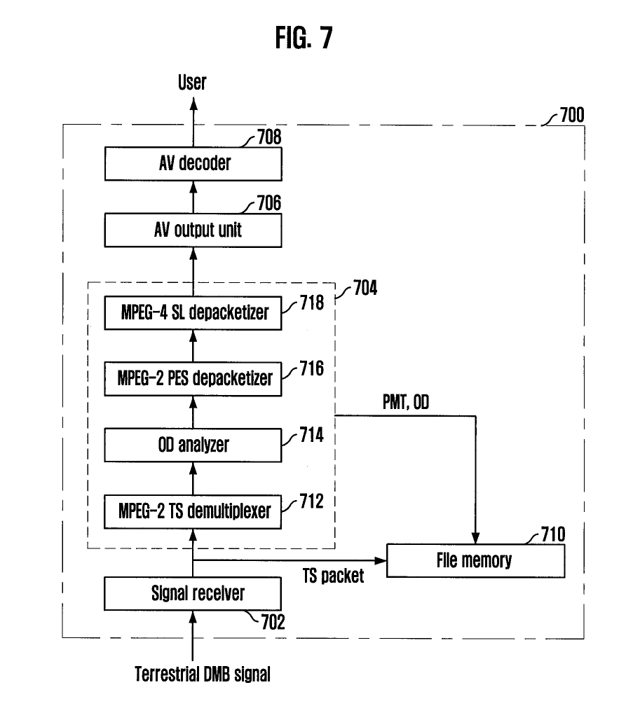

FIG. 7 is a block diagram illustrating a terrestrial DMB terminal in accordance with a second embodiment of the present invention.

Referring to FIG. 7, the terrestrial DMB terminal according to the second embodiment includes a signal receiver 702, a signal processor 704, an AV decoder 706, an AV output unit 708, and a file memory 710.

The signal receiver 702 receives a DMB signal, processes the received DMB signal, and outputs a DMB MPEG-2 TS. The signal processor 704 extracts PMT related information and OD information from the MPEG-2 TS outputted from the signal receiver 702 by a sample unit. The file memory 710 stores the outputted MPEG-2 TS from the signal receiver 702 in an mdat box of an ISO-based media file format as a sample and describes the extracted PMT information and OD information from the signal processor 704 in an moov box of the ISO-based media file format by a sample unit.

The signal processor 704 includes an MPEG-TS demultiplexer 712, an OD analyzer 714, an MPEG-2 PES depacketizer 716, and an MPEG-4 SL depacketizer 718. The file memory 710 includes an moov generator (not shown), and an mdat generator (not shown). Unlike the terminal shown in FIG. 1, the terminal 700 further includes the OD analyzer 714.

The MPEG-2 TS demultiplexer 712 demultiplexes an MPEG-2 TS outputted from the signal receiver 702 and informs the file memory 710 whether random access is possible or not based on the demultiplexing result. The OD analyzer 714 analyzes OD information in a PES packet header. The MPEG-2 PES depacketizer 716 receives PES packets and extracts SL packets by depacketizing the received PES packets. The MPEG-4 SL depacketizer 718 receives the MPEG-4 SL packets, depacketizes the received MPEG-4 SL packets, and extracts synchronization information. The AV decoder 706 decodes AV streams or images. The AV output unit 708 outputs the decoded AV stream or image to a user.

When a user records contents while receiving live broadcasting contents, TS packets analyzed through the MPEG-2 TS demultiplexer 712 are transmitted to the file memory 710 with the sample extraction information and are used to generate moov which is metadata for analyzing a file. Then, real TS packets are stored in the mdat.

FIG. 8 is a flowchart illustrating a method for storing MPEG-2 TS in accordance with a second embodiment of the present invention. At first, the file memory 710 stores a target MPEG-TS in an mdat box of an ISO-based media file format as a sample for random access at step S802. Then, PMT related information and OD information of the target MPEG-2 TS sample unit are described in the moov box at step S804.

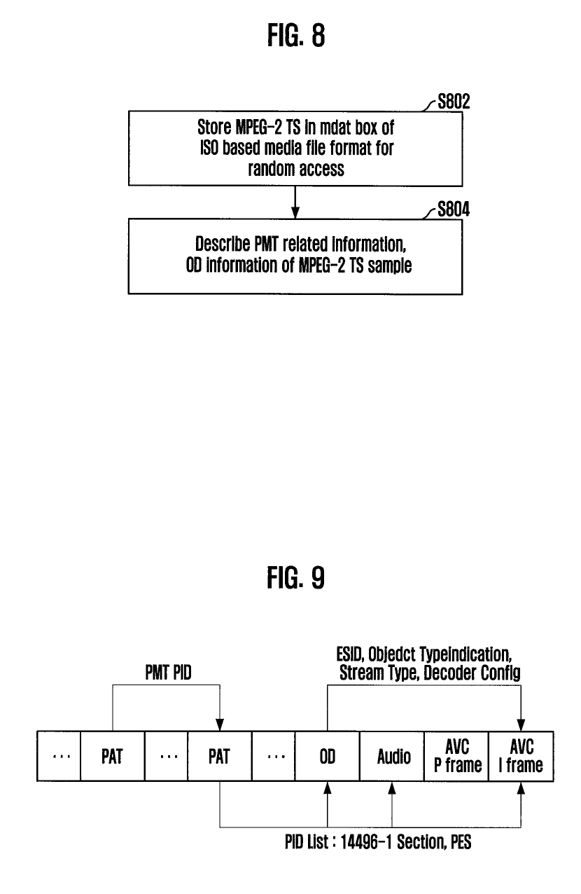

FIG. 9 is a diagram illustrating a structure of an MPEG-2 TS of a DMB contents storage method in accordance with an embodiment of the present invention.

In the DMB contents of FIG. 9, an Object Descriptor (OD) and a BInary Format for Scene (BIFS) of MPEG-4 system are used for AV reproducing scene and data in the DMB contents. In order to render one scene in general MPEG-4, a scene is initialized by analyzing an Initial Object Descriptor (IOD) in a Program Map Table (PMT), and a scene such as a graphic object and an event input is displayed by analyzing a corresponding OD and BIFS ES Descriptor and analyzing BIFS. Then, a corresponding object is rendered on an MIFS scene by obtaining decoding information for video, audio and images through analyzing the OD. Therefore, it is necessary to have not only a PMT of an MPEG-2 TS but also OD information in order to render data of a predetermined random time of a reproduced scene.

Table 3 shows TS information to be recorded in MPEG-2 TS Sample Entry of stbl according to the second embodiment and a sample descriptor that describes PMT information and OD information. If od_type is ‘1’, OD information is described through od_size and od_data.

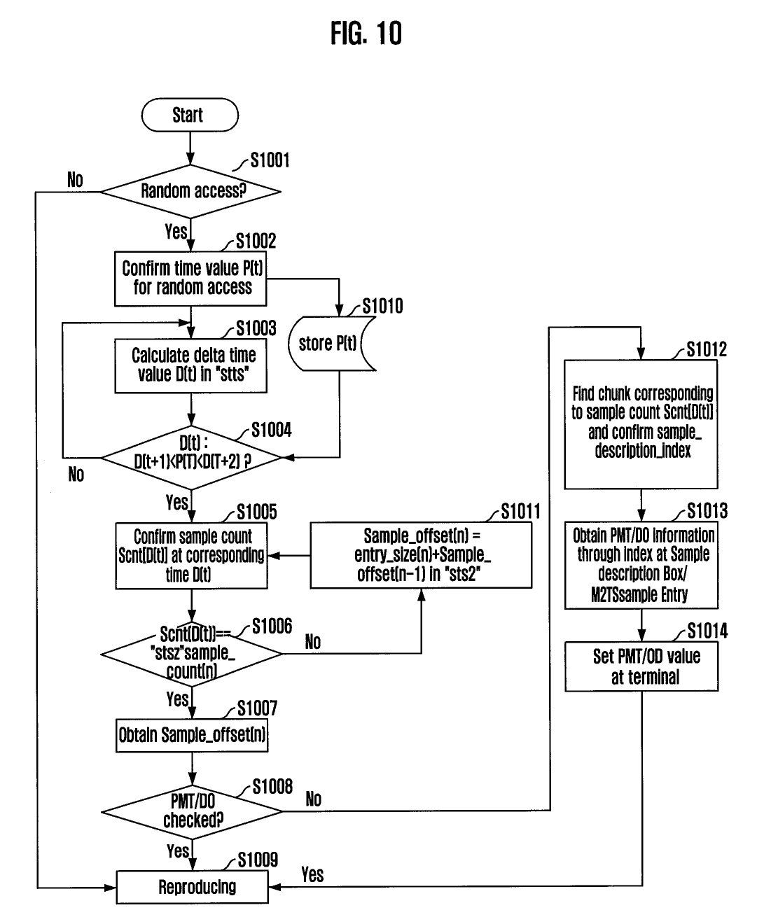

FIG. 10 is a flowchart illustrating relation between MPEG-2 TS and PMT/OD that is a sample descriptor according to a second embodiment of the present invention.

According to a proposed method, an encoded file is randomly accessed as follows. At first, a DMB file decoder loads an ISO-based stored DMB contents file for playback. The DMB file decoder analyzes an moov file for analyzing a file and initializes a demultiplexer by obtaining a PID after analyzing setups for TS analysis and a PMT defined in a stbl. After initializing the demultiplexer, the DMB file decoder prepares to draw a scene by setting up an initial OD through analyzing an OD of the stbl.

When a user moves to a random time region of contents while reproducing contents, a sample is formed as shown in FIG. 10. At first, a user selects a random time of contents using a Graphic User Interface (GUI) or other method at step S1001. Here, the DMB file decoder checks a time value P(t) that a user accesses at step S1002 and stores the time value P(t) at step S1010. Then, a delta value is detected from a stts of a file format and calculates D(t)(=delta(0)+delta(1)+delta(2) . . . +delta(t)) at step S1003. It calculates the closest time to the selected random time through D(t). If a corresponding time value is in between P(t) selected by a user at step S1004, a sample count Scnt (d(t)) of the corresponding time value D(t) is confirmed at step S1005. Then, it is determined whether “stsz” sample_count(n) is identical to Scnt or not at step S1006. If they are not identical, it is repeated until this condition is satisfied while calculating Sample_offset(n). It will be described in more detail as follows. That is, a physical location in a stored DMB file is detected and calculated based on a size according to a sample order described in stsz based on a confirmed sample at step S1011. If they are identical, it is possible to detect a file location for random access playback at a desired time value P(t) by obtaining Sample_offset(n). At this moment, a terminal needs PMT/OD information for playing back contents from a corresponding sample. Therefore, the PMT/OD information is confirmed at step S1008. If there is no PMT/OD information provided, sample_description_index is detected through chunk information and a sample number (sample_count) described in stsc at step S1012, and PMT/OD information of M2TSSampleEntry in Sample Description box is obtained at step S1013. Finally, it is set up at a DMB file decoder at step S1014 and the obtained random access location and PMT/OD information are reproduced through a decoder at step S1009.

### MODE FOR THE INVENTION

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

While the present invention has been described with respect to the specific embodiments, it will be apparent to those skilled in the art that various changes and modifications may be made without departing from the spirit and scope of the invention as defined in the following claims.

What is claimed is:

1. A method for storing a Moving Picture Expert Group (MPEG)-2 Transport Stream (TS) in an International Organization for Standardization (ISO) based media file format, comprising:
storing a target MPEG-2 TS in an mdat box of the ISO-based media file format;
dividing the MPEG-2 TS by samples through time information, location information, size information, and Program Map Table (PMT) related information for random access and describing the divided samples in an moov box of the ISO-based media file format.

2. The method of claim 1, wherein in said storing a target MPEG-2 TS and said dividing the MPEG-2 TS, the MPEG-2 TS is regarded as one sample.

3. The method of claim 1, wherein in said storing a target MPEG-2 TS and said dividing the MPEG-2 TS,
if a packet having a Random Access Indicator (RAI) equal to 1 includes a Program Clock Reference (PCR) value, one sample is defined from a first byte of the packet to a packet just before a next packet having an RAI equal to 1.

4. The method of claim 1, wherein in said storing a target MPEG-2 TS and said dividing the MPEG-2 TS,
if a packet having Random Access Indicator (RAI) equal to 1 does not include a Program Clock Reference (PCR) value, one sample is defined from a first byte of the packet to a packet just before a next packet having an RAI equal to 1 and having a PCR by predicting a time value based on the previous PCR value.

5. The method of claim 1, wherein in said storing a target MPEG-2 TS and said dividing the MPEG-2 TS,
if a packet having an RAI equal to 1 does not include a PCR value, a time value is predicted and obtained with reference to previous and next PCR values, the obtained time value is used as the time information, and one sample is defined from a first byte of a packet having RAI=1 to a previous packet of a next packet having an RAI equal to 1.

6. The method of claim 1, wherein one sample is defined from a first byte of a packet having an RAI equal to 1 to a previous packet of a next packet having an RAI equal to 1.

7. The method of claim 1, wherein time information described in the moov box is generated using a Presentation Time Stamp (PTS) of an MPEG-2 PES packet header obtained from an MPEG-2 TS stored in the mdat box.

8. The method of claim 1, wherein time information described in the moov box is generated using a Decoding Time Stamp of an MPEG-2 Packetized Elementary Stream (PES) packet header, which is obtained from an MPEG-2 TS stored in the mdat box.

9. The method of claim 1, wherein the time information described in the moov box is generated using DTS and PTS of an MPEG-2 PES packet header obtained from an MPEG-2 TS stored in the mdat box.

10. The method of claim 1, wherein if a payload of the MPEG-TS includes an MPEG-4 Synchronization Layer (SL) packet, time information described in the moov box is generated using a Decoding Time Stamp of the MPEG-4 SL packet header.

11. The method of claim 1, wherein if a payload of the MPEG-2 TS includes an MPEG-4 SL packet, time information described in the moov box is generated using a Composition Time Stamp of the MPEG-4 SL packet header.

12. The method of claim 12, wherein if a payload of the MPEG-2 TS includes an MPEG-4 SL packet, time information described in the moov box is generated using decoding time and composition time of the MPEG-4 SL packet header.

13. The method of claim 1, wherein the PMT related information is directly described in the moov box.

14. An apparatus for storing a Moving Picture Expert Group (MPEG)-2 transport stream in an International Organization for Standardization (ISO) based media file formation, comprising:
a signal receiver for receiving an external signal and outputting an MPEG-2 transport stream (TS);
a signal processor for extracting time information, location information, size information, and Program Map Table (PMT) related information by a sample unit from the MPEG-2 TS outputted from the signal receiver; and
a file memory for storing the MPEG-2 TS from the signal receiver in an mdat box of the ISO-based media file format as a sample for random access, and describing the extracted time information, location information, size information, and PMT related information in an moov box of the ISO-based media file format.

15. The apparatus of claim 14, wherein time information described in the moov box is generated using a Presentation Time Stamp (PTS) of an MPEG-2 PES packet header from the MPEG-2 TS stored in the mdat box.

16. The apparatus of claim 14, wherein time information described in the moov box is generated using a Decoding Time Stamp (DTS) of an MPEG-2 PES packet header obtained from an MPEG-2 TS stored in the mdat box.

17. The apparatus of claim 14, wherein if the payload of the MPEG-2 TS includes an MPEG-4 SL packet, the time information described in the moov box is generated using a decoding time of an MPEG-4 SL packet header.

18. The apparatus of claim 14, wherein if the payload of the MPEG-2 TS includes an MPEG-4 SL packet, the time information described in the moov box is generated using a composition time or a decoding time of the MPEG-4 SL packet header.

19. A Digital Multimedia Broadcasting (DMB) terminal, comprising:
a signal receiver for receiving a DMB signal and outputting an MPEG-2 transport stream (TS);
a file memory for storing the MPEG-2 TS in an International Organization for Standardization (ISO) based media file format where the MPEG-2 TS is stored in an mdat box of the ISO-based media file format as a sample, and time information, location information, size information, and Program Map Table (PMT) related information of the MPEG-2 TS are stored by a sample unit in an moov box of the ISO-based media file formation;
an MPEG-2 TS demultiplexer for analyzing PMT in the received MPEG-2 TS;
an OD analyzer for extracting or analyzing OD information from the analyzed information;
an MPEG-2 PES depacketizer and an MPEG-4 SL depacketizer for analyzing a packet through the analyzed or extracted PMT/OD information;
an AV decoder for decoding the generated AV stream; and
an AV output unit for outputting the decoded AV stream,
wherein radon access playback for an MPEG-2 transport stream stored in the mdat box is controlled using information described in the moov box.

20. The DMB terminal of claim 19, wherein a location of the random access playback is selected by a user based on the time information.

21. A method for storing a Digital Multimedia Broadcasting (DMB) MPEG-2 Transport Stream (TS) in an International Organization of Standard (ISO) based media file format, comprising:
storing a target MPEG-2 TS to store in an mdat box of the ISO-based media file format; and
describing time information, location information, Program Map Table (PMT) related information, and Object Descriptor (OD) information in an moov box of the ISO-based media file format by a sample unit for randomly accessing the target MPEG-2 TS, where a boundary of the sample is identical to a boundary of the MPEG-2 TS.

22. The method of claim 21, wherein the PMT related information and the OD related information are described in the moov box whenever the PMT related information and the OD related information are updated.

23. An apparatus for storing a Digital Multimedia Broadcasting (DMB) MPEG-2 Transport Stream (TS) in an International Organization for Standardization (ISO) based media file format, comprising:
a signal receiver for receiving an external signal and outputting an MPEG-2 TS;
a signal processor for extracting Program Map Table (PMT) related information and Object Descriptor (OD) related information from the MPEG-2 TS outputted from the signal receiver; and
a file memory for storing the outputted MPEG-2 TS from the signal receiver in an mdat box of the ISO-based media file format as a sample for random access, and describing time information, location information, Program Map Table (PMT) related information, and Object Descriptor (OD) related information of the extracted MPEG-2 TS from the signal processor in an moov box of the ISO-based media file format by a sample unit.
